(19) United States
(12) Patent Application Publication
(10) Pub. No.: US 2021/0347261 A1
(43) Pub. Date: Nov. 11, 2021

(54) DRIVER ANTI-DISTRACTION DEVICE (DADD)

(71) Applicant: MISC LLC, Purcellville, VA (US)

(72) Inventor: Carlos Manuel MAZA, Purcellville, VA (US)

(21) Appl. No.: 17/308,717

(22) Filed: May 5, 2021

Related U.S. Application Data
(60) Provisional application No. 63/020,438, filed on May 5, 2020.

(51) Int. Cl. B60K 35/00; B60W 40/08

(52) U.S. Cl. CPC B60K 35/00; B60W 40/08; B60W 2540/223; B60K 2370/178; B60K 2370/589; B60K 2370/782

(57) ABSTRACT

In an aspect, a driver anti-distraction device (DADD) is disclosed. The DADD includes: a memory; at least one communications interface; and at least one processor communicatively coupled to the memory and the at least one communications interface. The at least one processor, memory and at least one communications interface are configured to: monitor, via one or more sensors, a driver's hand position and grip on a steering wheel of a vehicle; detect that at least one hand of the driver is off the steering wheel; start a timer based on the detection; and transmit a message indicating a hands off violation, if the timer exceeds a preconfigured time.

### CROSS-REFERENCE TO RELATED APPLICATION

The present application for patent claims the benefit of U.S. Provisional Application No. 63/020,438, entitled “DRIVER ANTI-DISTRACTION DEVICE (DADD)”, filed May 5, 2020, which is hereby expressly incorporated by reference herein in its entirety.

### TECHNICAL FIELD

Aspects of this disclosure relate generally to a vehicle device to aid in detecting and/or preventing driver distraction. In some aspects sensor data is used to confirm appropriate driver contact with the steering wheel.

### BACKGROUND

Many vehicles manufactured today are equipped with numerous sensors, including cameras, radar, ultrasound and other sensors to provide feedback to the driver and aid in accident prevention. These sensors are used to detect an environment external to the vehicle, including other vehicles, obstacles and vulnerable road users (VRUs), such as pedestrians, cyclists, etc. However, these external sensors do not ensure that the vehicle driver is alert, in a non-distracted position and/or in proper control of the steering wheel. Accordingly, it would be beneficial to have a system to ensure that the vehicle driver is alert, is not distracted and in proper control of the steering wheel.

### SUMMARY

The following presents a simplified summary relating to one or more aspects disclosed herein. As such, the following summary should not be considered an extensive overview relating to all contemplated aspects, nor should the following summary be regarded to identify key or critical elements relating to all contemplated aspects or to delineate the scope associated with any specific aspect. Accordingly, the following summary has the sole purpose to present certain concepts relating to one or more aspects relating to the mechanisms disclosed herein in a simplified form to precede the detailed description presented below.

This summary identifies features of some example aspects and is not an exclusive or exhaustive description of the disclosed subject matter. Whether features or aspects are included in or omitted from this summary is not intended as indicative of relative importance of such features. Additional features and aspects are described and will become apparent to persons skilled in the art upon reading the following detailed description and viewing the drawings that form a part thereof.

In accordance with the various aspects disclosed herein, at least one aspect includes, a method of operating a driver anti-distraction device (DADD) in a vehicle, including: monitoring, via one or more sensors, a driver's hand position and grip on a steering wheel of the vehicle; detecting that at least one hand of the driver is off the steering wheel; starting a timer based on the detection; and transmitting a message indicating a hands off violation, if the timer exceeds a preconfigured time.

In accordance with the various aspects disclosed herein, at least one aspect includes, a driver anti-distraction device (DADD), including: a memory; at least one communications interface; and at least one processor communicatively coupled to the memory, the at least one communications interface, the at least one processor configured to: monitor, via one or more sensors, a driver's hand position and grip on a steering wheel of a vehicle; detect that at least one hand of the driver is off the steering wheel; start a timer based on the detection; and transmit a message indicating a hands off violation, if the timer exceeds a preconfigured time.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an exemplary driver anti-distraction device (DADD) in accordance with at least one aspect of the disclosure.

FIG. 2 illustrates block diagram of an exemplary driver anti-distraction device (DADD) in accordance with at least one aspect of the disclosure.

FIG. 3 illustrates a system level diagram including a driver anti-distraction device (DADD) in wireless communication with additional devices in accordance with at least one aspect of the disclosure.

FIG. 4 illustrates a flow chart for at least one method in accordance with at least one aspect of the disclosure.

### DETAILED DESCRIPTION

Aspects of the disclosure relate generally to a method and apparatus related to a vehicle anti-distraction device that can use sensor data from a steering wheel to allow for confirmation that the vehicle driver is not in a distracted state and further has control of the steering wheel. In a specific example, the sensor data can be used to ensure that the vehicle driver has an appropriate hand position and grip of the vehicle steering wheel, which in turn infers that the driver is not distracted and in a position to properly control the vehicle.

Aspects of the disclosure are provided in the following description and related drawings directed to various examples provided for illustration purposes. Alternate aspects may be devised without departing from the scope of the disclosure. Additionally, well-known aspects of the disclosure may not be described in detail or may be omitted so as not to obscure more relevant details.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., Application Specific Integrated Circuits (ASICs)), by program instructions being executed by one or more processors, or by a combination of both. In addition, for each of the aspects described herein, the corresponding form of any such aspect may be implemented as, for example, “logic configured to” perform the described action.

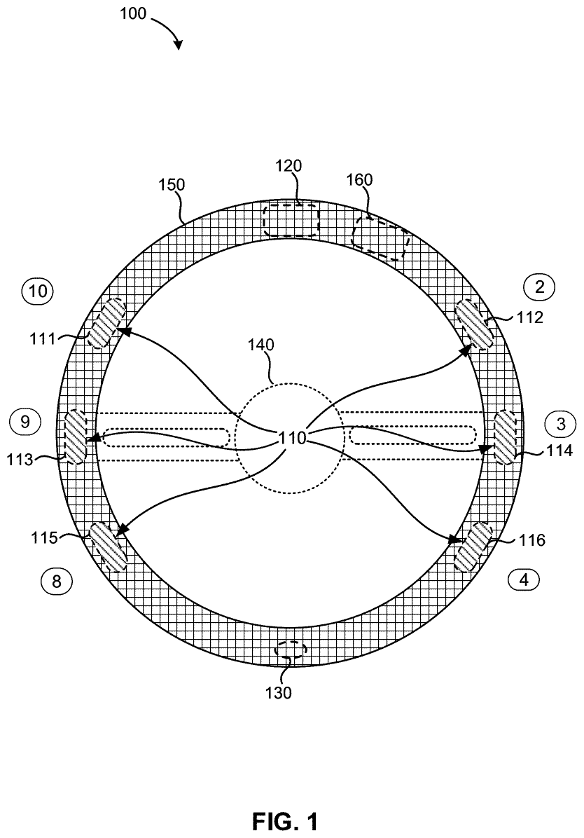

According to various aspects, FIG. 1 illustrates an exemplary system 100 according to at least one aspect of the disclosure. The system 100 may also be referred to herein as a Driver Anti-Distraction Device (DADD). The DADD 100 may include various components that are integrated into a sleeve 150 such as a control system 160 and hand position sensors 110, which may include specific sensors at designated locations. For example, sensors 111 and 112 may be used to detect hand positions at the 10 and 2o'clock positions, respectively. In addition to or as an alternative, sensors 113 and 114 may be used to detect hand positions at the 9 and 3 o'clock positions, respectively. Further, in addition to or as an alternative, sensors 115 and 116 may be used to detect hand positions at the 8 and 4 o'clock positions, respectively. A power supply 120 may optionally be included. Likewise, a power switch may optionally be provided. These optional devices, the power supply 120 and power switch 130 may also be included in the sleeve 150 that is configured to fit over and be secured to the steering wheel 140 of a vehicle. In some aspects, the DADD 100, may be realized as the sleeve with the integrated components discussed herein. The sleeve 150 may be constructed of various materials (e.g., leather, rubber, plastics, etc.) and may be secured in any suitable manner (e.g., lacing, friction, adhesive, etc.) as is well known by those skilled in the art. Further, in other aspects, the sleeve 150 may be integrated into the steering wheel 140 and provided as an integrated device by original equipment manufacturers or as replacement parts for the entire steering wheel assembly.

As noted above, the DADD 100 may include one or more hand position sensor 110, in alternative configurations, the hand position sensor 110 may have any suitable configuration to detect both grip and hand position. For example, hand position sensor 110 may be formed of one sensor that substantially extends around the sleeve 150 to allow for sensing hand position at least two for the designated locations (e.g., 10 and 2o'clock positions, 9 and 3 o'clock positions, and/or 8 and 4 o'clock positions). In another aspect the hand position sensor 110 may be formed of two sensors that substantially extends over portions of each side of the sleeve 150 to allow for sensing hand position at least two for the designated locations and in some configurations may extend over at least a 60 degree portion to cover each of the, 10 and 2o'clock positions, 9 and 3 o'clock positions, and 8 and 4 o'clock positions.

The hand position sensor(s) 110 may be any form of sensor that can be used to determine grip/contact, such as mechanical switches, capacitive sensors, pressure sensors, and the like, as known in the art. For example, in the illustrated example, the discrete sensors, e.g., sensors 111 and 112, may be physically located in the desired position, e.g., 10 and 2o'clock positions, respectively. Alternatively, a strip type sensor may be used to detect grip and position over a larger range. The hand position sensor(s) 110 may also be used to acquire additional data, such as temperature, pulse rate, grip pressure (e.g., insufficient gripping force indicating), as opposed to a binary indication, and other data, that may be beneficial to determine alertness, mental state, etc. This additional data may be acquired by an integrated sensor that can sense multiple data (e.g., pressure, temperature, etc.) or individual sensors that function to provide the various data integrated into a common position (e.g., independent temperature, contact, and/or pressure sensors, etc.). This data may be communicated to a smart phone, control system (e.g., infotainment system in the vehicle), relayed to remote monitoring devices, etc.

In some aspects the Driver Anti Distraction Device (DADD) 100 may be configured to work with a smartphone or other wireless mobile device to provide feedback. In some aspects the DADD 100 can allow for a driver's use of their smartphone to be restricted while the vehicle is in motion. In further aspects, the DADD can connect via Bluetooth to a suitably enabled smartphone and after you complete the initial setup, an audible alert may sound when the driver removes one hand from the steering wheel for a predetermined time span. Other functions may also be programmed, such as locking the phone when one or more hands are removed from the steering wheel for the predetermined time span. The smartphone owner (e.g., parent, employer, etc.) could also enable a feature that sends an audio alert to a designated device (e.g., parent's phone, central dispatch, etc.) so that the driving and texting habits of the vehicle driver can be monitored. The DADD 100 may also be used by courts to monitor and enforce restrictions on drivers for drivers who habitually text while driving or have otherwise been adjudicated to be a distracted driver. The DADD 100 could be used along with software installed in a smartphone infotainment system or other dedicated monitoring device, by a judge, magistrate or other authority to monitor and/or log the driving patterns, in regards to hand contact with the wheel and other data that can be obtained from the DADD 100 and associated software as discussed herein. For example, a court could delegate a company to monitor the alerts when the driver removes their hands from the steering while driving and thus consider alternative remediation to include suspending their driver's license. Insurance companies could also be interested in the DADD 100 as a way to ensure that young driver's or repeat offenders are not texting while driving as part of their insurance coverage. Further, by determining hand position on the steering wheel, the DADD 100 may be used as an aid in training drivers in the proper hand position and driving techniques.

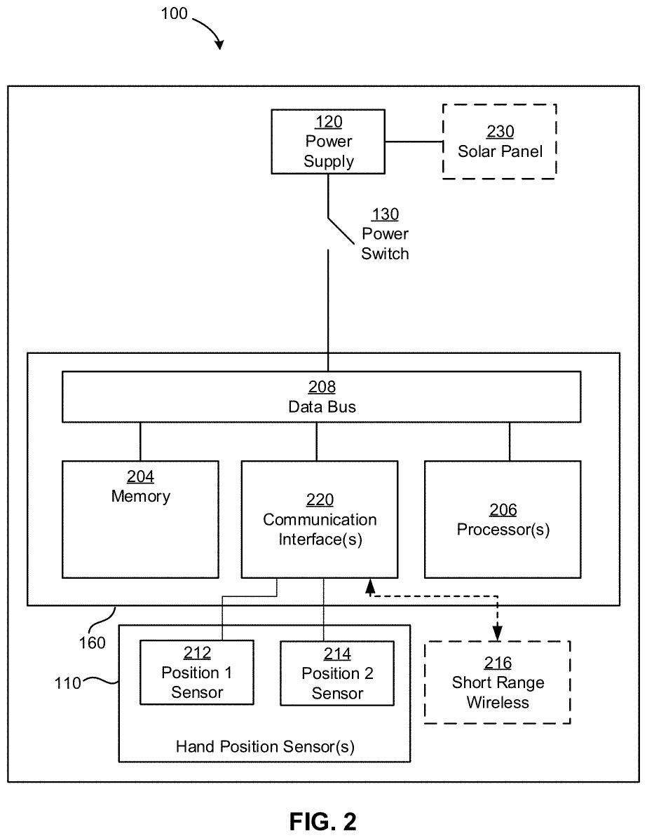

FIG. 2 illustrates a control system 160 of the DADD 100, according to various aspects. In an aspect, the control system 160 includes a non-transitory computer-readable storage medium, i.e., memory 204, and one or more processors 206 in communication with the memory 204 via a data bus 208. The memory 204 includes one or more storage modules storing computer-readable instructions executable by the processor(s) 206 to perform the functions of the DADD 100 described herein.

One or more hand position sensors 110 are coupled to the control system 160. In some aspects, the hand position sensor(s) 110 may include two or more discrete sensors, such as a position 1 sensor 212 (e.g., sensors 111, 113 or 115, at the 10, 9 or 8 o'clock positions, respectively in FIG. 1). A position 2 sensor 214 (e.g., sensors 112, 114 or 116, at the 2, 3 or 4 o'clock positions, respectively in FIG. 1), The control system 160 also includes one or more communication interfaces 220 connecting the processor(s) 206, by way of the data bus 208, to the hand position sensor(s) 110, and in some cases, a short range wireless interface 216, such as one or more of Bluetooth, Bluetooth low-energy (Bluetooth LE), ZigBee, Z-Wave, near field communication (NFC), WiFi Direct, and the like. In some further aspects, the one or more communication interfaces 220 may additionally include a network interface to connect to one or more networks (e.g., a wireless LTE, 5G NR, global positioning systems (GPS) networks, cellular telecommunication networks, wired connections to the vehicle, etc.).

In an aspect, the control system 160 may utilize the communication interfaces 220 to communicate the hand sensor data to an external device via a direct connection to the vehicle or via a wireless connection using short range wireless interface 216. Generally, Bluetooth will be used for simplicity of description herein, but the various aspects are not limited to Bluetooth and any suitable short range wireless technology, such as those listed in the foregoing, may be used according to the various aspects disclosed.

In accordance with the various aspects disclosed herein, at least one aspect includes, a driver anti-distraction device (DADD), including: a memory; at least one communications interface; and at least one processor communicatively coupled to the memory, the at least one communications interface, the at least one processor configured to: monitor, via one or more sensors, a driver's hand position and grip on a steering wheel of a vehicle; detect that at least one hand of the driver is off the steering wheel; start a timer based on the detection; and transmit a message indicating a hands off violation, if the timer exceeds a preconfigured time.

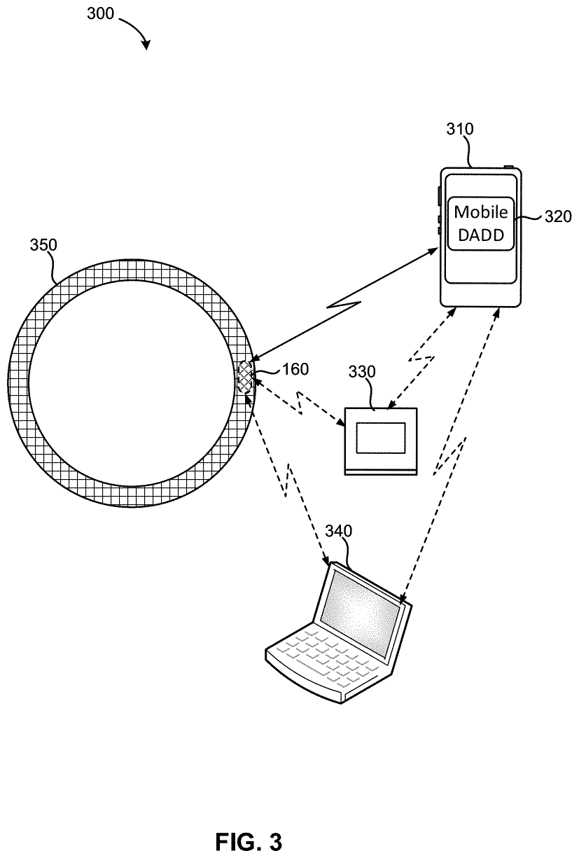

FIG. 3 illustrates a system level diagram including a Driver Anti-Distraction Device (DADD) 350 in wireless communication with additional devices in accordance with at least one aspect of the disclosure. The DADD 350 may be similar to the DADD 100 discussed in the foregoing. Accordingly, detailed discussion of the hand position sensors, power supply, etc. will not be provided herein for brevity. As illustrated DADD 350 includes a control system 160 that may be similar to the control system 160 discussed in the foregoing, including a short range wireless interface for communicating to a smartphone 310. The smartphone 310 may be configured with a mobile DADD application 320 to facilitate communication, setup and control of the DADD 350. The control system 160 via the short range wireless interface may optionally communicate to a vehicle control system 330 (e.g., an infotainment system or other suitable controller) and/or optionally a remote computer system 340 (e.g., which may be a laptop, desktop, dedicated dispatch system, or any other suitable computing device). It will be appreciated that the smartphone 310 may also relay either raw data or conditioned data and/or reports to the vehicle control system 330 and/or remote computer system 340. Additionally, as discussed above, in some aspects, especially if the DADD 350 is integrated into the steering wheel, the DADD 350 may communicate over a physical interface to the vehicle control system 330. Accordingly, it will be appreciated the various illustrated communication paths and components are merely provided for explanation and should not be construed to limit the various aspects disclosed to the illustrated aspects.

In some aspects, the DADD 350 may be installed by placing the DADD 350 (configured as a sleeve) over the steering wheel of the vehicle. To initiate the system 300, the DADD 350 may be powered up. After powering up, the smartphone may be started up, if not active and of the mobile DADD application 320 is not installed, it may be downloaded from an appropriate application store or source. Once the mobile DADD application 320 is open on the smartphone 310, a registration process can be performed for the DADD 350, if the DADD 350 had not previously been registered/paired with the smartphone 310 and mobile DADD application 320. After registration/pairing, a set-up menu can be selected in the mobile DADD application 320 on the smartphone to configure the DADD 350. Various parameters may be configured for the DADD 350, such as:
Selecting a preferred hand placement (e.g., 10 and 2o'clock positions, 9 and 3 o'clock positions, and/or 8 and 4 o'clock positions, and/or the entire circumference).
Selecting the time lapse before alerts sound when you remove either hand off the DADD350.
Selecting to invite others (e.g., via email, text, etc.) that you wish or are required to share your alerts with (such as parent, court monitoring, insurance company, etc.)
   Additional aspects may be configured in the mobile DADD application 320 and the foregoing items are basic functions are merely provided for examples and should not be construed to limit the various aspects disclosed to these specific aspects.

In accordance with the various aspects disclosed herein, at least one aspect can include a driver anti-distraction device (DADD) (e.g., 100, 350) including: a memory (e.g., 204); at least one communications interface (e.g., 220); and at least one processor (e.g., 206) communicatively coupled to the memory and at least one communications interface. The at least one communications interface and the at least one processor being configured to monitor, via one or more sensors (e.g., 110), a driver's hand position and grip on a steering wheel of a vehicle. The at least one processor being configured detect that at least one hand of the driver is off the steering wheel and start a timer based on the detection. The at least one communications interface and the at least one processor being configured to transmit a message indicating a hands-off violation, if the timer exceeds a preconfigured time.

In view of the foregoing it will be appreciated that various additional aspects are disclosed herein. For example, the DADD 100, 350 includes the driver's hand position being at a designated position. The designated position includes at least one of: a 10 o'clock and 2o'clock position, a 9 o'clock and 3 o'clock position, or an 8 o'clock and 4 o'clock position. The DADD 100, 350 may further include at least two sensors (e.g., 111, 112, 113, 114, 115 and/or 116) located relative to the steering wheel in at least one of: a 10 o'clock and 2o'clock position, a 9 o'clock and 3 o'clock position, or an 8 o'clock and 4 o'clock position. The DADD 100, 350, in some aspects, may include two sensors located over opposite sides of the steering wheel and where each sensor covers at least a sixty-degree portion of the steering wheel, thereby allowing for detection of multiple positions. The DADD 100, 350, in some aspects, may further include a short-range wireless interface (e.g., 216) configured to wirelessly communicate the message (e.g. to a smartphone, etc.). The short-range wireless interface can be configured to operate using at least one of a Bluetooth, Bluetooth low-energy (Bluetooth LE), ZigBee, Z-Wave, near field communication (NFC), or WiFi Direct protocol. The DADD 100, 350 may further include a power supply 120 configured to provide power to the DADD 100, 350. In some aspects, control system 160 may be integrated into a common component or package with the power supply 120. The power supply may be a battery or in aspects may be supplied from an external supply. In some aspects, a solar panel 230 or solar cell may be provided that is configured to charge the battery and/or provide direct power. The foregoing are merely some example implementations according to the various aspects disclosed. Accordingly, it will be appreciated the various implementations are merely provided for explanation and should not be construed to limit the various aspects disclosed.

In view of the foregoing it will be appreciated that various aspects disclosed may be described as techniques, processes and/or methods for performing the various functionalities disclosed or apparent from the disclosure provided herein.

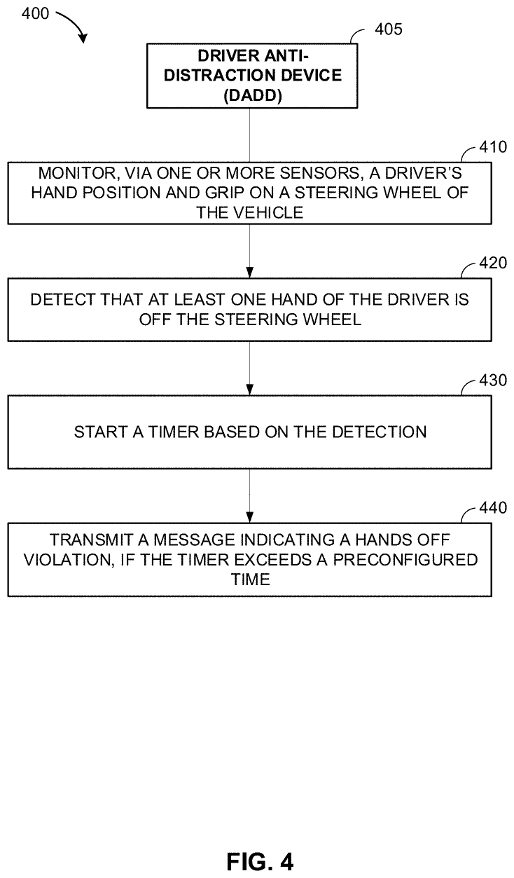

FIG. 4 is a flow diagram illustrating an example method 400 in accordance with at least one aspect of the disclosure. The method 400 may be performed, for example, by the driver anti-distraction device (DADD) 405, which may be mounted to or integrated into a steering wheel of a vehicle, and may be similar to DADD 100, 350, discussed in the foregoing.

Referring to FIG. 4, at block 410, the DADD 405 monitors, via one or more sensors, a driver's hand position and grip on a steering wheel of the vehicle. At block 420, the DADD 405, detects that at least one hand of the driver is off the steering wheel. At block 430, the DADD 405, starts a timer based on the detection. At block 440, the DADD 405, transmits a message indicating a hands-off violation, if the timer exceeds a preconfigured time.

It will be appreciated that the various aspects include various implementations as discussed herein. For example, at least one aspect may include the driver's hand position being at a designated position, where the designated position includes at least one of: a 10 o'clock and 2o'clock position, a 9 o'clock and 3 o'clock position, or an 8 o'clock and 4 o'clock position. Further aspects may include detecting a hand position violation, if the driver's hands are not at the designated position and transmitting a message indicating a hand position violation. In some aspects, the hand position violation may be detected even if both hands are detected to be gripping the steering wheel. For example, the hand position violation can be valuable as training tool to novice drivers. Additional aspects may include detecting a grip pressure of each hand of the driver, instead of merely a binary detection of the grip (e.g. as may be determined by a simple mechanical sensor).

Further aspects may include detecting a temperature of at least one hand of the driver. This may be used for validation that a live hand is actually gripping the wheel, as opposed to some clamp or device being used to defeat the system. Further, the temperature may be used as part of additional biofeedback to determine potential stress levels, etc. The method further including: receiving the preconfigured time from an authorized user. In some aspects, the preconfigured time may be communicated wirelessly to the DADD 405, as discussed in the foregoing (e.g., via Bluetooth from the mobile DADD application). In some aspects, the preconfigured time may be set to a default value at a time of manufacture and in may be coded such that the preconfigured time cannot be modified. This may be useful in situations, such as court ordered monitoring, to avoid tampering with the timer operation. In further aspects, the preconfigured time may be adjusted based on a speed of the vehicle, so the preconfigured time is reduced as the speed increases. Since the distances traveled and potential danger is greater at higher speeds, the time duration resulting in a violation being transmitted may be adjusted to account for the speed of the vehicle.

Still further, it will be appreciated that the functionalities discussed here in in relation to the example aspects may be distributed between the DADD and the mobile DADD application and/or other device operatively coupled to the DADD. For example, in some aspects that DADD may just provide raw sensor data and the decisions regarding whether there is hands-off condition, sufficient pressure, etc. may be performed in whole or part by the mobile DADD application or other coupled device. Accordingly, it will be appreciated that the various alternative and additional aspects described in the foregoing are merely provided for explanation and should not be construed to limit the various aspects disclosed.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

In view of the descriptions and explanations above, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Accordingly, it will be appreciated, for example, that an apparatus or any component of an apparatus may be configured to (or made operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

Moreover, the methods, sequences, and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor (e.g., cache memory).

Accordingly, it will also be appreciated, for example, that certain aspects of the disclosure can include a computer-readable medium embodying the methods described herein.

While the foregoing disclosure shows various illustrative aspects, it should be noted that various changes and modifications may be made to the illustrated examples without departing from the scope defined by the appended claims. The present disclosure is not intended to be limited to the specifically illustrated examples alone. For example, unless otherwise noted, the functions, steps, and/or actions of the method claims in accordance with the aspects of the disclosure described herein need not be performed in any particular order. Furthermore, although certain aspects may be described or claimed in the singular, the plural is contemplated unless limitation to the singular is explicitly stated.

What is claimed is:

1. A method of operating a driver anti-distraction device (DADD) in a vehicle, comprising:
monitoring, via one or more sensors, a driver's hand position and grip on a steering wheel of the vehicle;
detecting that at least one hand of the driver is off the steering wheel;
starting a timer based on the detection; and
transmitting a message indicating a hands off violation, if the timer exceeds a preconfigured time.

2. The method of claim 1,
wherein the driver's hand position includes the driver's hands being at a designated position, the designated position including at least one of:
a 10 o'clock and 2o'clock position,
a 9 o'clock and 3 o'clock position, or
an 8 o'clock and 4 o'clock position.

3. The method of claim 2, further comprising:
detecting a hand position violation, if the driver's hands are not at the designated position; and
transmitting a message indicating a hand position violation.

4. The method of claim 3, wherein the hand position violation is detected even if both hands are detected to be gripping the steering wheel, wherein at least one hand does have an insufficient gripping force.

5. The method of claim 1, further comprising:
detecting a grip pressure of each hand of the driver.

6. The method of claim 1, further comprising:
detecting at least one of a temperature or pulse rate from at least one hand of the driver.

7. The method of claim 1, further comprising:
receiving the preconfigured time from an authorized user.

8. The method of claim 7, wherein the preconfigured time is communicated wirelessly to the DADD.

9. The method of claim 1, wherein the preconfigured time is set to a default value at a time of manufacture.

10. The method of claim 1, wherein the preconfigured time is adjusted based on a speed of the vehicle, the preconfigured time being reduced as the speed increases.

11. A driver anti-distraction device (DADD), comprising:
a memory;
at least one communications interface; and
at least one processor communicatively coupled to the memory and the at least one communications interface, wherein the at least one communications interface and the at least one processor are configured to:
monitor, via one or more sensors, a driver's hand position and grip on a steering wheel of a vehicle;
detect that at least one hand of the driver is off the steering wheel;
start a timer based on the detection; and
transmit a message indicating a hands off violation, if the timer exceeds a preconfigured time.

12. The DADD of claim 11, wherein the driver's hand position includes the driver's hands being at a designated position, the designated position including at least one of:
a 10 o'clock and 2o'clock position,
a 9 o'clock and 3 o'clock position, or
an 8 o'clock and 4 o'clock position.

13. The DADD of claim 11, wherein the one or more sensors are at least two sensors located relative to the steering wheel at least one of:
a 10 o'clock and 2o'clock position,
a 9 o'clock and 3 o'clock position, or
an 8 o'clock and 4 o'clock position.

14. The DADD of claim 11, wherein the one or more sensors are two sensors located over opposite sides of the steering wheel and wherein each sensor covers at least a sixty degree portion of the steering wheel.

15. The DADD of claim 11, wherein the one or more sensors are configured to detect at least one of:
a grip pressure of each hand of the driver; or
a temperature of at least one hand of the driver.

16. The DADD of claim 11, further comprising:
a short range wireless interface configured to wirelessly communicate the message.

17. The DADD of claim 11, further comprising:
a power supply configured to provide power to the DADD.

18. The DADD of claim 17, wherein the power supply comprises at least one of:
a battery; or
a solar panel.

19. The DADD of claim 11, wherein the DADD is a sleeve configured to fit over the steering wheel.

20. The DADD of claim 11, wherein the DADD is integrated into the steering wheel.
